(19) United States
(12) Patent Application Publication
(10) Pub. No.: US 2022/0313020 A1
(43) Pub. Date: Oct. 6, 2022

(54) HERB GRINDER

(71) Applicant: Zachary Shick, Lansing, MI (US)

(72) Inventor: Zachary Shick, Lansing, MI (US)

(21) Appl. No.: 17/571,696

(22) Filed: Jan. 10, 2022

Related U.S. Application Data
(60) Provisional application No. 63/171,108, filed on Apr. 6, 2021.

(51) Int. Cl. A47J 42/42; A24B 7/06; A47J 42/14

(52) U.S. Cl. CPC A47J 42/42; A24B 7/06; A47J 42/14

(57) ABSTRACT

A herb grinder system may have a tubular housing with a top portion, a bottom portion, an internal bore, and a side wall opening, the top portion having a top surface and a bottom surface, a first set of teeth extending away from the bottom surface of the top portion, a lid rotatably connected to the top surface of the top portion which forms a grinding chamber configured to receive herb, a second set of teeth extending away from an inner surface of the lid into configuration with the first set of teeth, a plurality of apertures being defined by a floor of the grinding chamber which allow herb to exit the grinding chamber, and a collection chamber having a diameter less than that of the tubular housing which is slidably removed from the side wall opening of the tubular housing.

### FIELD

The present disclosure relates to grinders and, more specifically, grinders that grind herbal matter.

### BACKGROUND

Generally, herb grinders are cylindrical devices divided into two halves with sharp ridges or teeth aligned such that when the halves are united and rotated with respect to each other, the herb or other material inside is reduced in size. Many herb grinders also have cylindrical collection chambers connected to one of the two halves using a threaded attachment that collects the pulverized material. A by-product of the grinding process is resin that accumulates in the threaded attachment. The resin can make assembly and disassembly of the grinder more difficult. The object of the present disclosure is to facilitate access to herb after it is pulverized and avoid the need for frequent cleaning of the system.

### SUMMARY

In one implementation, a herb grinder system may have a tubular housing comprising a top portion, a bottom portion, an internal bore, and a side wall opening, the top portion having a top surface and a bottom surface, a first set of teeth extending away from the bottom surface of the top portion, a lid rotatably connected to the top surface of the top portion, the lid forming a grinding chamber configured to receive herb, a second set of teeth extending away from an inner surface of the lid into configuration with the first set of teeth, a plurality of apertures being defined by a floor of the grinding chamber, the apertures allowing ground herbs to exit the grinding chamber, and a collection chamber having a diameter less than that of the tubular housing, wherein the collection chamber is slidably removed from the side wall opening of the tubular housing.

In another implementation, a herb grinder system may have a tubular housing comprising a grinding chamber, a removably connected upper collection chamber, and a removably connected lower collection chamber, the upper chamber having a replaceable screen, wherein the upper collection chamber is configured to abut the grinding chamber and the lower collection chamber, wherein the upper collection chamber and lower collection chamber having a diameter less than that of the tubular housing, and wherein the upper collection chamber and lower collection chamber are configured to be slidably removed from the side wall opening of the tubular housing.

### BRIEF DESCRIPTION OF THE DRAWINGS

FIG. 1 is a perspective view illustrating an embodiment of an herb grinder system;

FIG. 2 is a perspective view of another embodiment of the collection chamber shown in FIG. 1;

FIG. 3 is a sectional view of another embodiment of the herb grinder system; and

FIG. 4 is a perspective view of another embodiment of an herb grinder system.

### DETAILED DESCRIPTION

The illustrations provided herein are directed to an herb grinder system for grinding herb. At least one of the embodiments disclosed includes a tubular housing having a top portion and a bottom portion. The top portion of the tubular housing and a lid collectively define a grinding chamber where herb can be inserted to be made smaller. The bottom portion includes an internal bore and a side wall opening. The bottom portion of the tubular housing further includes a collection chamber that is slidably removable from the internal bore. The collection chamber is in communication with the grinding chamber which collects herb as it is ground.

The herb grinder system may be used to pulverize tobacco, herbs. spices, and, other materials. Previous herb grinders, such as those employing threaded collection chambers, suffer from resin accumulation in the threads, making it difficult to disassemble the collection chamber to access pulverized herb. The present disclosure provides an herb grinder system that is relatively easy to clean and improves accessibility to herb after it is pulverized.

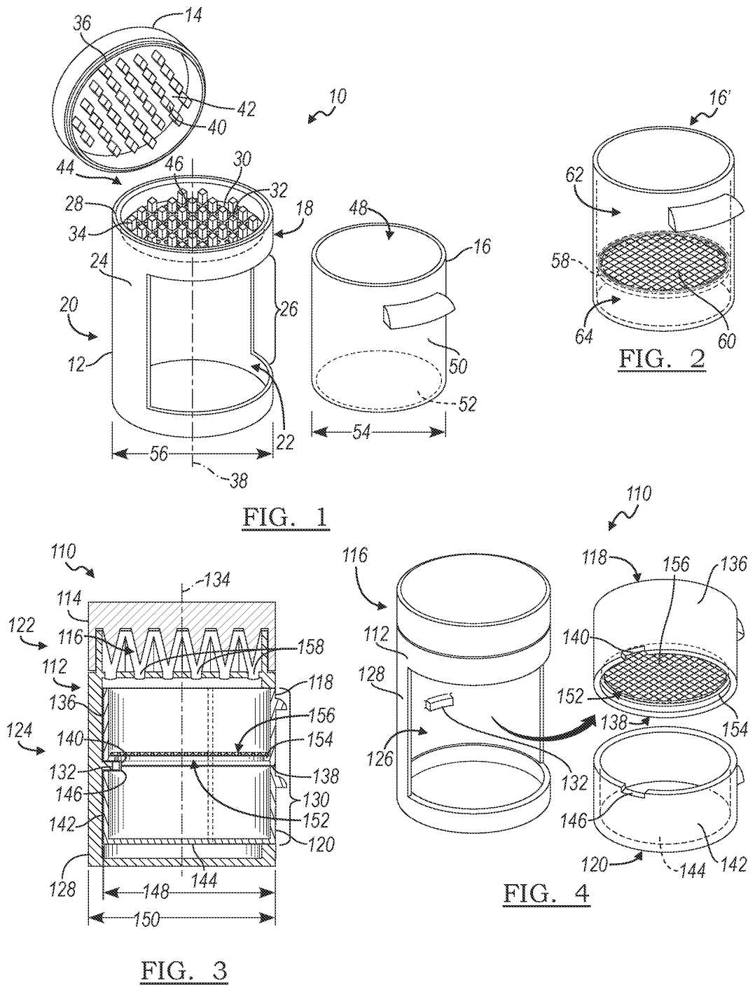

Referring in more detail to FIGS. 1-2, an herb grinder system is illustrated. The first embodiment of the herb grinder system 10 includes a tubular housing 12, a lid 14, and a collection chamber 16. The tubular housing 12 comprising a top portion 18, a bottom portion 20, an internal bore 22, a side wall 24, and a side wall opening 26. The top portion 18 having a top surface 28 and a bottom surface 30. The bottom surface 30 of the top portion 18 may have a first set of teeth 32 extending away from the bottom surface 30. The first set of teeth 32 are provided with blades 34 having a modified diamond shape, but other shapes are possible. The first set of teeth 32 may be positioned in a circular pattern on the bottom surface 30 such that another set of teeth can confront the teeth 32 but do not interfere during the grinding process.

The tubular housing 12 may be made of machined metal and formed from round bar stock by subtractive manufacturing. The tubular housing 12 may also be made of plastic and formed in a mold. Other suitable materials and manufacturing methods may also be used to manufacture the tubular housing 12. FIG. 1 depicts the tubular housing 12 having a round side wall 24, however, other cross-sectional shapes are possible. For example, the cross section of the tubular housing 12 may be hexagonal, rectangular, oblong, or symmetric. In at least one instance, the bottom portion 20 of the tubular housing 12 includes one or more sides to help a user grip the system. The lid 14 may also have one or more sides to help a user grip the lid. The cross section of the lid 14 may correspond to the cross section of the tubular housing 12, but it is not required.

With continued reference to FIG. 1, the lid 14 is rotatably connected to the top surface 28. A magnet 36 may be provided on the lid 14 such that it attracts to the tubular housing 12 or another magnet situated on the tubular housing 12. The magnets help keep the system assembled while still allowing the lid 14 to rotate about a central axis 38 of the tubular housing 12 to grind herb. The lid 14 includes a second set of teeth 40 extending away from an inner surface 42 of the lid 14 and into confrontation with the first set of teeth 32. The tubular housing 12 and the lid 14 collectively define a grinding chamber 44 configured to receive herb. A plurality of apertures 46 are defined by the bottom surface 30 of the top portion 18 and allow smaller herb particles to pass through and amass in the collection chamber 16. The size and shape of the apertures 46 control the size of herb particles that pass through and collect in the collection chamber 16. For instance, the bottom surface 30 may include any combination of small circular apertures 46 that allow small herb particles to pass through as well as oblong or oval apertures (not shown) that allow larger herb particles to pass through. The apertures 46 may be other shapes and may be positioned on the bottom surface 30 with respect to the position of the first set of teeth 32.

The collection chamber 16 includes an interior region 48 defined by an outer wall 50 and an underside 52. The collection chamber 16 is slidably removed from the side wall opening 26 in a direction perpendicular to the central axis 38 of tubular housing 12. The diameter 54 of the collection chamber 16 is less than the diameter 56 of the tubular housing 12 such that when it is slidably inserted in the side wall opening 26, the outer wall 50 is adjacent and/or abuts the side wall 24 of the tubular housing 12.

FIG. 2 shows an alternate embodiment for a collection chamber 16′ having an internal lip 58 extending radially inwardly to support a replaceable screen 60. The replaceable screen 60 separates the collection chamber 16′ into a first region 62 and a second region 64. The internal lip 58 may be positioned so that the volume of the first region and the volume of the second region are similar. However, as shown in FIG. 2, it is preferred that the volume of the first region is greater that the volume of the second region. The first region 62 captures herb having a diameter that is greater than that collected in the second region 64. The replaceable screen 60 may be a sieve that separates coarser herb particles from finer particles. For example, the replaceable screen 60 may include a mesh portion such that the second region 64 only collects herb trichomes, pollen, and other fine herb particles. The mesh of the replaceable screen 60 may include holes with a diameter of 20 microns to 160 microns but ideally between 70 microns to 120 microns.

The herb grinder system 10 may be used to grind herbs, spices, tobacco, and other dried plants into particulates. In order to grind herb, a user may remove the lid 14 and place herb in the grinding chamber 44. The user may then replace the lid 14 on the tubular housing 12 and rotate the lid 14 in a clockwise or counterclockwise direction. Rotating the lid 14 rotates the first set of teeth 32 in a direction that is relative to the second set of teeth 40 which grinds, pulverizes, and makes the herb smaller. After one or more rotations of the lid 14, the herb may be reduced in size such that it begins to pass through the apertures 46. Herb is collected in the interior region 48 of the collection chamber 16. In some embodiments, very fine particles, such as trichomes or pollen, continue to pass through the replaceable screen 60 and collect in the second region 64 of the collection chamber 16′. After the grinding process is complete, the user may remove the slidably removable collection chamber 16, 16′ from the tubular housing 12 to access the herb particles.

Another embodiment of an herb grinder system 110 is depicted in FIGS. 3-4. The herb grinder system 110 comprises a tubular housing 112 including a lid 114, a grinding chamber 116 a slidably removable upper collection chamber 118, and a slidably removeable lower collection chamber 120. The tubular housing 112 may include a top portion 122, a bottom portion 124, an internal bore 126, a side wall 128, and a side wall opening 130.

The side wall 128 having an internal key 132 protruding inwardly toward a central axis 134 of the tubular housing 112. The internal key 132 can assist with aligning and vertically constraining the upper collection chamber 118 and lower collection chamber 120 in the tubular housing 112. After herb is ground to make it smaller, the herb may be accessed by either removing the upper collection chamber 118, the lower collection chamber 120, or both. The internal key 132 can support the upper collection chamber 118 in the tubular housing 112 when the lower collection chamber 120 is slidably removed. The internal key 132 can also align the lower collection chamber 120 in the tubular housing 112 when the upper collection chamber 118 is slidably removed.

The upper collection chamber 118 may include an outer wall 136, an underside 138, and a notch 140. Similarly, the lower collection chamber 120 may include an outer wall 142, an underside 144, and a notch 146. Both the upper collection chamber 118 and lower collection chamber 120 share a similar diameter 148 that is less than the diameter 150 of the tubular housing 112, such that they are configured to be slidably removed from the side wall opening 130 of the tubular housing 112. FIG. 3 shows the upper collection chamber 118 and the lower collection chamber 120 having a similar cross-sectional volume, however, it is possible for the upper collection chamber 118 to have a greater cross-sectional volume compared to the cross-sectional volume of the lower collection chamber 120.

The notch 140 on the upper collection chamber 118 and the notch 146 on the lower collection chamber 120 align with at least a portion of the internal key 132 such that the internal key 132 allows each chamber to be slidably removed and inserted into the tubular housing 112. The internal key 132 does not interfere with grinding herb and does not prevent herb from traveling from the top portion 122 of the tubular housing 112 to the bottom portion 124 of the tubular housing 112. The internal key 132 also allows the upper collection chamber 118 and lower collection 120 to be slidably inserted such that the outer walls 136, 142 of both chambers are adjacent and/or abuts the side wall 128 of the tubular housing 112.

Now referring to FIG. 4, the underside 138 of the upper collection chamber 118 includes a through hole 152. The remaining portion of the underside 138 of the upper collection chamber 118 forms an internal rim 154 that extends inwardly and provides annular support for a replaceable screen 156. As shown in FIG. 4, the replaceable screen 156 abuts the internal rim 154 and covers the through hole 152 of the upper collection chamber 118.

The upper collection chamber 118 is configured to abut the grinding chamber 116 and the lower collection chamber 120. The upper collection chamber 118 and the grinding chamber 116 are in communication with each other such that the upper collection chamber 118 collects particles that results when herb is made smaller and passes through the apertures 158 of the grinding chamber 116. The upper collection chamber 118 and the lower collection chamber 120 are in communication such that the lower collection chamber 120 collects fine herb particles that pass through the replaceable screen 156 of the upper collection chamber 118. The replaceable screen 156 is configured similar to the replaceable screen 60 of the first embodiment such that the upper collection chamber 118 collects herb with a coarser grain size than that collected in the lower collection chamber 120. The replaceable screen 156 may include mesh having holes with a diameter of 20 microns to 160 microns but ideally between 70 microns to 120 microns.

The disclosure is not limited to one of the embodiments described above but is able to be modified in many different ways.

All of the features and advantages disclosed from the claims, the description and the drawings, including structural details, spatial arrangements and method steps, may be essential to the invention both per se and in all types of combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A herb grinder system comprising:
a tubular housing comprising a top portion, a bottom portion, an internal bore, and a side wall opening, the top portion having a top surface and a bottom surface, a first set of teeth extending away from the bottom surface of the top portion;
a lid rotatably connected to the top surface of the top portion, the lid forming a grinding chamber configured to receive herb, a second set of teeth extending away from an inner surface of the lid into configuration with the first set of teeth, a plurality of apertures being defined by a floor of the grinding chamber, the apertures allowing ground herbs to exit the grinding chamber; and
a collection chamber having a diameter less than that of the tubular housing, wherein the collection chamber is slidably removed from the side wall opening of the tubular housing.

2. The herb grinder system as recited in claim 1, wherein the tubular housing, the lid, and the collection chamber may be made of metal.

3. The herb grinder system as recited in claim 1, wherein the lid comprises a magnet that is configured to releasably bias the lid toward another magnet or magnetic surface on the tubular housing.

4. The herb grinder system as recited in claim 1, wherein the collection chamber comprises an internal lip that supports a replaceable screen.

5. The herb grinder system as recited in claim 4, wherein the replaceable screen separates the collection chamber into a first region and a second region.

6. The herb grinder system as recited in claim 5, wherein the first region collects herb having a grain size that is greater than herb collected in the second region.

7. A herb grinder system comprising:
a tubular housing comprising a grinding chamber, a removably connected upper collection chamber, and a removably connected lower collection chamber, the upper chamber having a replaceable screen;
wherein the upper collection chamber is configured to abut the grinding chamber and the lower collection chamber;
wherein the upper collection chamber and lower collection chamber having a diameter less than that of the tubular housing; and
wherein the upper collection chamber and lower collection chamber are configured to be slidably removed from the side wall opening of the tubular housing.

8. The herb grinder system as recited in claim 7, wherein the tubular housing, the lid, and the collection chamber may be made of metal.

9. The herb grinder system as recited in claim 7, wherein the tubular housing has an internal key protruding inwardly from the side wall of the tubular housing toward a central axis of the tubular housing.

10. The herb grinder system as recited in claim 9, wherein the internal key does not interfere with herb traveling from the top portion of the tubular housing to the bottom portion of the tubular housing.

11. The herb grinder system as recited in claim 10, wherein the upper collection chamber and lower collection both comprise a notch corresponding to the internal key.

12. The herb grinder system as recited in claim 11, wherein the notch of the upper collection chamber and the notch of the lower collection chamber align with at least a portion of the internal key, aligning the upper collection chamber and the lower collection chamber.

13. The herb grinder system as recited in claim 7, wherein the upper collection chamber comprises an underside having a through hole, forming an internal rim.

14. The herb grinder system as recited in claim 13, wherein a replaceable screen abuts the internal rim and covers the through hole of the upper collection chamber.

15. The herb grinder system as recited in claim 7, wherein the upper collection chamber collects herb having a grain size that is greater than herb collected in the lower collection chamber.
